(19) United States
(12) Patent Application Publication
(10) Pub. No.: US 2013/0014730 A1
(43) Pub. Date: Jan. 17, 2013

(54) VAPORIZED FUEL TREATMENT APPARATUS FOR VEHICLE

(71) Applicants: Takeshi SHIMURA, Wako-shi (JP); Takahiro IMAMURA, Wako-shi (JP)

(72) Inventors: Takeshi SHIMURA, Wako-shi (JP); Takahiro IMAMURA, Wako-shi (JP)

(21) Appl. No.: 13/542,343

(22) Filed: Jul. 5, 2012

(30) Foreign Application Priority Data
Jul. 14, 2011 (JP) 2011-155592

(51) Int. Cl. F02M 33/02

(52) U.S. Cl. 123/520

(57) ABSTRACT

A vaporized fuel treatment apparatus for a vehicle including a fuel tank for storing fuel therein with an openable and closable gas filler cap attached to the fuel tank. A vaporized fuel storage is operatively connected to a charge path through which the fuel tank communicates with the vaporized fuel storage and a purge path through which the vaporized fuel storage communicates with an intake system of an internal-combustion engine. A lid covers the gas filler cap to be opened and closed and is supported on a vehicle body. The vaporized fuel treatment apparatus is provided with a positive-pressure adjustment valve for opening when the internal pressure of the fuel tank reaches a predetermined pressure, allowing the fuel tank to communicate with the vaporized fuel storage. The positive-pressure adjustment valve opens when the lid is opened.

### CROSS-REFERENCE TO RELATED APPLICATIONS

The present application claims priority under 35 USC 119 to Japanese Patent Application No. 2011-155592 filed Jul. 14, 2011 the entire contents of which are hereby incorporated by reference.

### BACKGROUND OF THE INVENTION

1. Field of the Invention

The present invention relates to a vaporized fuel treatment apparatus for vehicle for guiding vaporized fuel generated inside a fuel tank to the ambient air outside the fuel tank.

2. Description of Background Art

Japanese Patent Application Publication No. 2004-156496 discloses a system for a vaporized fuel treatment apparatus for a vehicle having a sealed fuel tank. The system electrically controls the internal pressure of the tank to prevent leakage of vaporized fuel or fuel from a gas filler neck to the ambient air outside the tank in a gas filling operation when the internal pressure of the tank is high.

The system according to Japanese Patent Application Publication No. 2004-156496 can be preferably used for relatively large vehicles, such as four-wheeled vehicles. However, such a system is not really suitable for motorcycles and the like that have less space and require a low cost, and wherein a gas filler neck has to be opened and closed directly with a key operation.

### SUMMARY AND OBJECTS OF THE INVENTION

The present invention has been made under such circumstances, and aims to provide a vaporized fuel treatment apparatus for a vehicle that prevents leakage of vaporized fuel to the atmosphere with a simple configuration and which can be suitably used for a small vehicle.

For the purpose of solving the above-mentioned problems, an embodiment of the present invention provides a vaporized fuel treatment apparatus for a vehicle including a fuel tank (2, 31) that stores fuel therein; an openable and closable gas filler cap (4, 33) attached to a gas filler neck (3, 32) of the fuel tank (2, 31); a vaporized fuel storage (6) that adsorbs vaporized fuel with an adsorbent and stores therein the vaporized fuel; a charge path (5) through which the fuel tank (2, 31) communicates with the vaporized fuel storage (6); a purge path (8) through which the vaporized fuel storage (6) communicates with an intake system (7) of an internal-combustion engine; and a lid (10, 28) that covers the gas filler cap (4, 33) in an openably and closably manner and is supported on the vehicle body. The vaporized fuel treatment apparatus for vehicle further includes an on-off valve (16, 47) that is located between the charge path (5) and the fuel tank (2, 31), and opens when an internal pressure of the fuel tank (2, 31) reaches a predetermined pressure, allowing the fuel tank (2, 31) to communicate with the vaporized fuel storage (6). The on-off valve (16, 47) also opens in conjunction with an opening action of the lid (10, 28) at a time of gas filling, and upon the opening action of the lid (10, 28) before an opening action of the gas filler cap (4, 33), the fuel tank (2, 31) is caused to communicate with the vaporized fuel storage (6) to release the vaporized fuel in the fuel tank (2, 31) to the vaporized fuel storage (6).

Note that the lid referred to in the present invention means a member which functions as a lid, and includes a seat placed on a vehicle.

According to an embodiment of the present invention, the lid (10) has a hinge arm part (11), and is rotatably supported by the hinge arm part (11) at a hinge shaft (13) held by a vehicle-body cover (9) covering the fuel tank (2). The on-off valve (16) is located inside the vehicle-body cover (9). The on-off valve (16) is opened by an action of the hinge arm part (11).

According to an embodiment of the present invention, the on-off valve (16) includes a valve body (17), a spring (19) that biases the valve body (17) in a closing direction, and a first permanent magnet (20) attached to the valve body (17), and is provided inside a valve housing part (14) provided in an outer wall of the fuel tank (2) at a position adjacent to the gas filler cap (4). The valve housing part (14) communicates with an inside of the fuel tank (2) via the on-off valve (16), and is connected to the charge path (5). The hinge arm part (11) has a second permanent magnet (21) placed at such a position so as to approach the first permanent magnet (20) upon the opening action of the lid (10).

According to an embodiment of the present invention, the on-off valve (16) includes a positive-pressure adjustment valve that opens when the internal pressure of the fuel tank (2) is a predetermined value or above and a negative-pressure adjustment valve that opens when the internal pressure of the fuel tank (2) is a predetermined value or below. The valve housing part (14) has a predetermined volume as a vapor-liquid separation chamber. The first permanent magnet (20) is provided to the positive-pressure adjustment valve. An arcuate depressed portion (14B) depressing toward an inside of the valve housing part (14) is provided to a wall portion of the valve housing part (14), the wall portion facing the positive-pressure adjustment valve, and facing the second permanent magnet (21) of the hinge arm part (11) when the lid (19) is opened.

According to an embodiment of the present invention, the valve housing part (14) is located in an upper wall portion of the fuel tank (2), and the charge path (5) is connected to a top surface of the valve housing part (14) at a position which is a center of the valve housing part 14 in a vehicle-width direction when mounted on the vehicle body, and which is at an area having no depressed portion (14B).

According to an embodiment of the present invention, the on-off valve (16) includes a valve body (17), a spring (19) that biases the valve body (17) in a closing direction, and a first permanent magnet (20) attached to the valve body (17), and is provided inside a valve housing part (14) provided in an outer wall of the fuel tank (2) at a position adjacent to the gas filler cap (4). An electric magnet (26) is provided outside the valve housing part (14). A switch contact portion (23) that separates from an inner wall of the vehicle-body cover (9) upon an opening action of the lid (10) is provided to the hinge arm part (11), and a switch (24) with which the switch contact portion (23) comes into contact when the lid (10) is closed is provided in the inner wall of the vehicle-body cover (9). Upon an opening action of the lid (10), the switch (24) sends a lid open detection signal to a control device (25). A current is inputted into the electric magnet (26) in response to a lid open determination made by the control device (25), and the on-off valve (16) is opened by a magnetic force.

According to an embodiment of the present invention, the on-off valve (16) includes a valve body (17), a spring (19) that biases the valve body (17) in a closing direction, and a first permanent magnet (20) attached to the valve body (17), and is provided inside a valve housing part (14) provided in an outer wall of the fuel tank (2). An electric magnet (26) is provided outside the valve housing part (14), and a press-type switch (24) is provided to any one of the fuel tank (2) and the valve housing part (14). A switch contact portion (23) that presses the switch (24) upon an opening action of the lid (10) is provided to the hinge arm part (11). When the switch contact portion (23) presses the switch (24) in response to the opening action of the lid (10), a current is inputted into the electric magnet (26), and the on-off valve (16) is opened by a magnetic force.

According to an embodiment of the present invention, a latch (60) that keeps the lid (28) closed is provided at the vehicle body supporting the lid (28). The on-off valve (47) opens in conjunction with a releasing action of the latch (60).

According to an embodiment of the present invention, the lid (28) is a seat of a motorcycle. In addition, the fuel tank (31) is covered with the seat.

According to an embodiment of the present invention, by making the on-off valve open in conjunction with the opening action of the lid performed before the gas filler cap is opened, the internal pressure of the fuel tank can be released toward the vaporized fuel storage before the gas filler cap is opened. This can prevent vaporized fuel from leaking to the atmosphere when the gas filler cap is opened. Such leaks are caused by the internal pressure of the fuel tank. Further, since the vaporized-fuel leak to the atmosphere can be prevented with a simple configuration utilizing the opening action of the lid, the present invention is very convenient and can be preferably used for a small vehicle.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows the overall configuration of a vaporized fuel treatment apparatus according to a first embodiment of the present invention;

FIG. 2 is a cross-sectional view of a main part of the vaporized fuel treatment apparatus according to the first embodiment;

FIG. 3 is a cross-sectional view of a main part of a vaporized fuel treatment apparatus according to a second embodiment of the present invention;

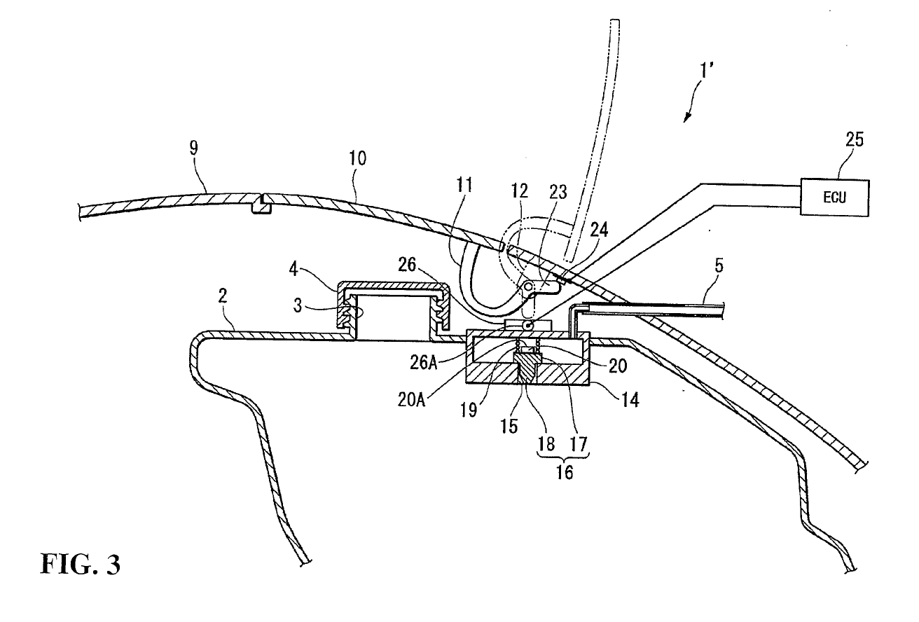

FIG. 4 shows the overall configuration of a vaporized fuel treatment apparatus according to a third embodiment of the present invention;

FIG. 5 is a cross-sectional view of a main part of the vaporized fuel treatment apparatus according to the third embodiment;

FIG. 6 is a cross-sectional view of a main part of the vaporized fuel treatment apparatus, illustrating how the vaporized fuel treatment apparatus according to the third embodiment works;

FIG. 7 is a cross-sectional view of a main part of a vaporized fuel treatment apparatus according to a modified example of the vaporized fuel treatment apparatus of the third embodiment; and

FIG. 8 is a cross-sectional view of a main part of a vaporized fuel treatment apparatus according to a modified example of the vaporized fuel treatment apparatus of the second embodiment.

### DETAILED DESCRIPTION OF THE PREFERRED EMBODIMENTS

Embodiments of the present invention will be described below with reference to the drawings. In the drawings referred to in the description below, UP indicates up, and FR indicates front. For convenience of description, the embodiments below will be described based on these directions.

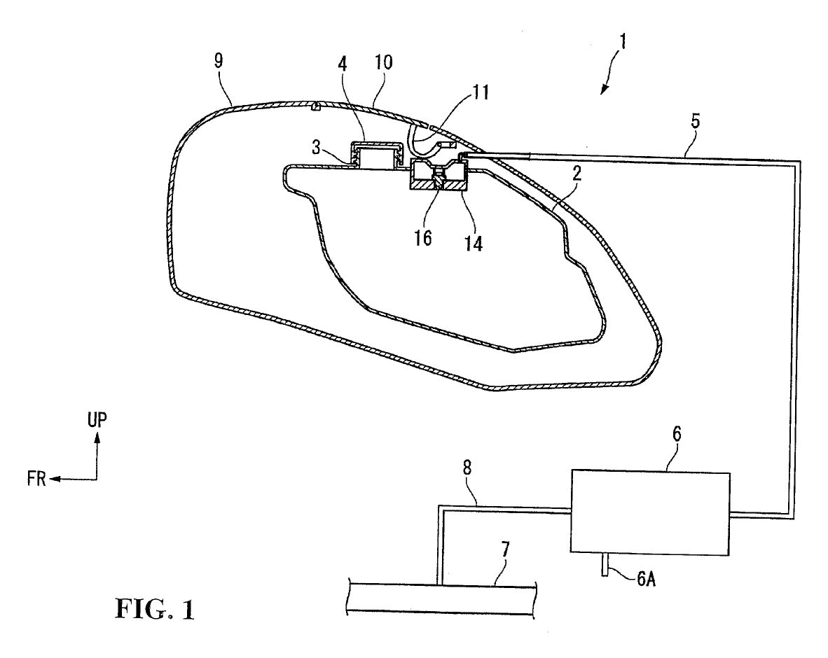

FIG. 1 shows the overall configuration of a vaporized fuel treatment apparatus 1, according to a first embodiment, applied to a fuel tank of a motorcycle. The vaporized fuel treatment apparatus 1 includes a fuel tank 2, a gas filler cap 4 attached openably and closably to a gas filler neck 3 of the fuel tank 2, a tubular charge pipe 5 that is made of a resin material or the like and communicates with the inside of the fuel tank 2, a vaporized fuel storage 6 connected to the charge pipe 5 outside of the fuel tank 2, and a purge pipe 8 through which the vaporized fuel storage 6 communicates with a connecting tube 7 constituting a part of an intake system.

The vaporized fuel storage 6 is provided with a drain pipe 6A that intakes air. A vehicle-body cover 9 is provided for covering the fuel tank 2. An openable and closable lid 10 is provided to the vehicle-body cover 9 at a position above the gas filler cap 4. When the lid 10 is opened, the gas filler cap 4 is exposed to the outside of the vehicle-body cover 9. The gas filler cap 4 is threadably screwed onto the gas filler neck 3.

The charge pipe 5 communicates with the inside of the fuel tank 2 via a valve housing part 14 to be described later, and transfers vaporized fuel generated inside the fuel tank 2 to the vaporized fuel storage 6. The vaporized fuel storage 6 has an adsorbent inside that adsorbs the vaporized fuel having been transferred through the charge pipe 5, and stores the vaporized fuel therein.

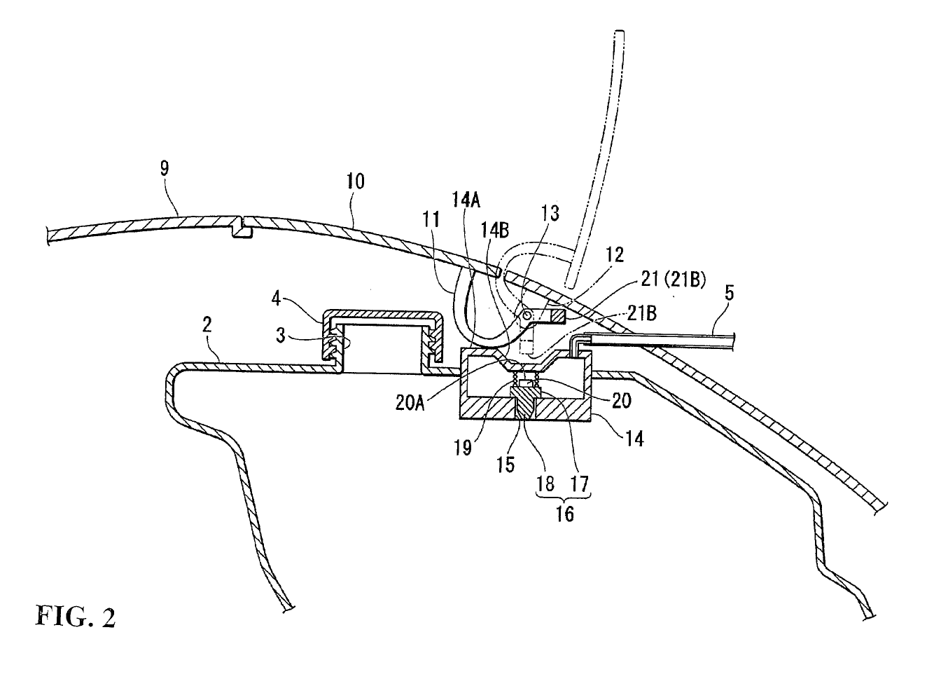

As FIG. 2 shows, the lid 10 includes a hinge arm part 11 on an inner-side surface thereof. Through the hinge arm part 11, the lid 10 is rotatably supported by a hinge shaft 13 supported at an inner wall of the vehicle-body cover 9 via a bracket 12. Note that the hinge arm part 11 may be integral with the lid 10 or attached separately.

The fuel tank 2 is provided with the valve housing part 14 mentioned earlier below the hinge shaft 13. The valve housing part 14 penetrates a top wall portion of the fuel tank 2 and is provided to a position adjacent to the gas filler cap 4. Note that the valve housing part 14 may be placed on the top wall portion of the fuel tank 2. The valve housing part 14 has a certain space (of a predetermined volume) inside as a vapor-liquid separation chamber. This space communicates with the charge pipe 5. Further, a housing hole 15 communicating with the inside of the fuel tank 2 is formed in a lower portion of the valve housing part 14. This housing hole 15 holds a positive-pressure adjustment valve 16 that is an on-off valve. Although not illustrated, another housing hole similar to the above housing hole 15 is formed in the valve housing part 14, and this hole is provided with a negative-pressure adjustment valve.

The positive-pressure adjustment valve 16 includes an umbrella portion 17 that closes the housing hole 15 by coming into contact with an upper edge of the housing hole 15, and a shaft portion 18 that extends downward from the umbrella portion 17 and is inserted into the housing hole 15. A spring 19 is provided between the umbrella portion 17 and an inner surface of an upper wall of the valve housing part 14. Thereby, the positive-pressure adjustment valve 16 is biased in a valve-closing direction, and appropriately opens when the internal pressure of the fuel tank 2 reaches a predetermined pressure (i.e., when the internal pressure has a predetermined pressure or above). Note that the umbrella portion 17 corresponds to the valve body in the present invention. Further, the negative-pressure adjustment valve mentioned earlier appropriately opens when the internal pressure of the fuel tank 2 is a predetermined pressure or below.

In the present embodiment, a first permanent magnet 20 is provided on an upper portion of the umbrella portion 17 of the positive-pressure adjustment valve 16, while a second permanent magnet 21 is provided to the hinge arm part 11 at its tip end side. When the lid 10 is opened, the tip end side of the hinge aim part 11 rotates and shifts its position downward, approaching the positive-pressure adjustment valve 16 side. As a result, when the lid 10 is opened, the second permanent magnet 21 shifts its position to approach the first permanent magnet 20.

The first permanent magnet 20 and the second permanent magnet 21 are provided to the hinge arm part 11 and the positive-pressure adjustment valve 16, respectively, so that magnetic poles different from each other may face in a vertical direction when the second permanent magnet 21 shifts its position to approach the first permanent magnet 20. In the present example, the first permanent magnet 20 has an N pole 20A at an upper part thereof, and the second permanent magnet 21 has an S pole 21B at such a position that the S pole 21B may face in the direction in which the tip end of the hinge arm part 11 extends.

The valve housing part 14 has a top wall portion 14A provided with an arcuate depressed portion 14B depressing toward the inside of the valve housing part 14. The first permanent magnet 20 is located below the backside of a bottom portion of the depressed portion 14B, in other words, at a position facing this backside of the bottom portion. Upon the opening action of the lid 10, the second permanent magnet 21 of the hinge arm part 11 shifts its position downward along the slope of the depressed portion 14B from the outside of the depressed portion 14B, and then shifts its position to face a top surface of the bottom portion of the depressed portion 14B.

The fuel tank 2 is configured so that, when the fuel tank 2 is mounted on the vehicle body, the lateral direction of the valve housing part 14 aligns with the vehicle-width direction. In the present embodiment, the charge pipe 5 described above is connected to the top surface of the valve housing part 14 at a position being the center of the valve housing part 14 in the vehicle-width direction and being at an area having no depressed portion 14B.

In the vaporized fuel treatment apparatus 1 configured as above, when the lid 10 is opened, the second permanent magnet 21 provided to the hinge arm part 11 approaches the first permanent magnet 20, and the magnet poles being different from each other (i.e., the S pole 21B and the N pole 20A) of the second permanent magnet 21 and the first permanent magnet 20, respectively, face each other. Thereby, the first permanent magnet 20 can be attracted to the second permanent magnet 21. This enables the positive-pressure adjustment valve 16 to open to transfer the internal pressure of the fuel tank 2 out to the vaporized fuel storage 6 side.

As described above, the vaporized fuel treatment apparatus 1 described above includes the fuel tank 2 in which fuel is stored, the openable and closable gas filler cap 4 attached to the gas filler neck 3 of the fuel tank 2, the vaporized fuel storage 6, the charge pipe 5 through which the fuel tank 2 communicates with the vaporized fuel storage 6, the purge pipe 8 through which the vaporized fuel storage 6 communicates with the intake system, and the lid 10 that covers the gas filler cap 4 openably and closably and is supported at the vehicle body side. The vaporized fuel treatment apparatus 1 further includes the positive-pressure adjustment valve 16 that is located between the charge pipe 5 and the fuel tank 2 and opens when the internal pressure of the fuel tank 2 reaches a predetermined pressure, allowing the fuel tank 2 to communicate with the vaporized fuel storage 6. Moreover, the positive-pressure adjustment valve 16 opens when the lid 10 is opened.

To be more specific, in the vaporized fuel treatment apparatus 1 described above, the positive-pressure adjustment valve 16 is provided inside the valve housing part 14 that penetrates the outer wall of the fuel tank 2 and which is provided adjacent to the gas filler cap 4. The positive-pressure adjustment valve 16 has the first permanent magnet 20. The valve housing part 14 communicates with the inside of the fuel tank 2 via the positive-pressure adjustment valve 16, and is connected to the charge pipe 5. Moreover, the lid 10 has the hinge arm part 11 that rotatably supports the lid 10 at the hinge shaft 13 held by the vehicle-body cover 9 covering the fuel tank 2. The hinge arm part 11 has the second permanent magnet 21 placed so as to approach the first permanent magnet 20 when the lid 10 is opened. Such a configuration allows the positive-pressure adjustment valve 16 to open when the lid 10 is opened.

Accordingly, by making the positive-pressure adjustment valve 16 open in conjunction with the opening action of the lid 10 performed before the gas filler cap 4 is opened, the internal pressure of the fuel tank 2 can be released toward the vaporized fuel storage 6 before the gas filler cap 4 is opened, preventing leakage of vaporized fuel to the atmosphere when the gas filler cap 4 is opened, such leakage is caused by the internal pressure of the fuel tank 2. Further, since the vaporized-fuel leak to the atmosphere can be prevented with a simple configuration utilizing the opening action of the lid 10, the present invention is very convenient and can be preferably used for a small vehicle.

Furthermore, in the embodiment described above, the first permanent magnet 20 is provided to the positive-pressure adjustment valve 16, and the arcuate depressed portion 14B depressing toward the inside of the valve housing part 14 is provided in the top wall portion of the valve housing part 14. The top wall portion is a wall portion that faces the positive-pressure adjustment valve 16 and, when the lid 10 is opened, faces the second permanent magnet 21 of the hinge arm part 11. In such a configuration, since the first permanent magnet 20 is provided to the position-pressure adjustment valve 16 that opens toward the outside of the fuel tank 2, the configuration for opening the positive-pressure adjustment valve 16 can be made simple and small. In addition, since the first permanent magnet 20 and the second permanent magnet 21 can approach each other as much as possible while allowing for enough volume for the vapor-liquid separation chamber in the valve housing part 14, these magnets can be reduced in size.

Further, the charge pipe 5 is connected to the upper surface of the valve housing part 14 at a position that is the center in the vehicle-width direction of the valve housing part 14 when mounted on the vehicle and being at an area having no depressed portion 14B. This configuration makes it unlikely for fuel accumulated in the valve housing part 14 (the vapor-liquid separation chamber) to enter the charge pipe 5 even when the body of a motorcycle banks, and therefore can avoid fuel back-flow.

In the configuration described in the above embodiment, the positive-pressure adjustment valve is used as a valve which is designed to open when the internal pressure of the fuel tank 2 rises and which is opened by the opening action of the lid 10. However, the negative-pressure adjustment valve may be opened instead. Note that a configuration using both of the positive-pressure adjustment valve and the negative-pressure adjustment valve allows the fuel tank to be in a sealed state until the fuel tank reaches a predetermined pressure, and therefore can reduce the amount of vaporized fuel transferred to the vaporized fuel storage.

A negative-pressure adjustment valve using a spring has a configuration in which its valve body is biased from the inside to the outside of the fuel tank. To open the negative-pressure adjustment valve, the magnets need to be provided so that they repel each other when the first permanent magnet attached to the hinge arm part 11 approaches the second permanent magnet provided at the negative-pressure adjustment valve side.

A second embodiment of the present invention will be described next. Note that components similar to the components in the first embodiment have the same reference numbers as the ones in the first embodiment and are not described again.

In a vaporized fuel treatment apparatus 1′ of the present embodiment, a switch contact portion 23 is formed at a tip side of the hinge arm part 11. The switch contact portion 23 separates from the inner wall of the vehicle-body cover 9 when the lid 10 is opened. A switch 24 of a push-button type (press type) is provided to the inner wall of the vehicle-body cover 9. The switch 24 comes into contact with the switch contact portion 23 when the lid 10 is closed. When the lid 10 is opened, the switch contact portion 23 separates from the switch 24.

The switch 24 is connected electrically to an ECU (Engine Control Unit) 25 that is a control device. The ECU 25 detects separation of the switch contact portion 23 when the switch contact portion 23 has separated from the switch 24. To be more specific, upon an opening action of the lid 10, the switch 24 sends the ECU 25 a lid open detection signal, and the ECU 25 determines whether the lid 10 is open or not (lid open determination) based on the lid open detection signal from the switch 24.

An electric magnet 26 is provided on the outside of the valve housing part 14 at an upper portion thereof, and is connected electrically to the ECU 25 through a harness 26A.

In the configuration of the present embodiment, when the ECU 25 detects that the switch contact portion 23 has separated, a current is inputted into the electric magnet 26 by the control of the ECU 25.

Thereby, when the lid 10 is opened, a magnetic force to attract the first permanent magnet 20 of the positive-pressure adjustment valve 16 is generated at the electric magnet 26, allowing the positive-pressure adjustment valve 16 to open.

Note that, although the positive-pressure adjustment valve 16 is opened in the present embodiment too, the negative-pressure adjustment valve may be opened instead.

A third embodiment of the present invention will be described next.

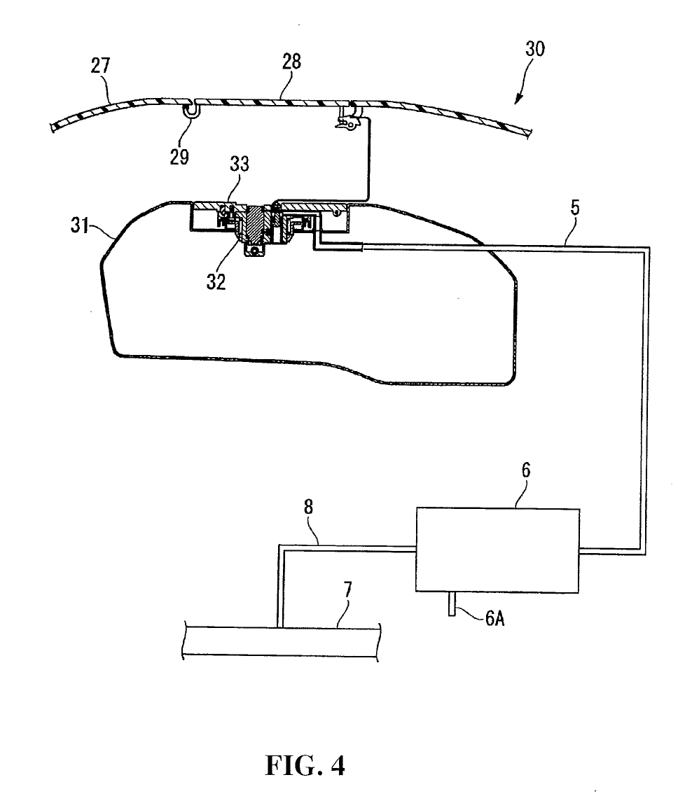

FIG. 4 shows the overall configuration of a vaporized fuel treatment apparatus 30 according to the third embodiment of the present invention. The vaporized fuel treatment apparatus 30 includes a fuel tank 31, a gas filler cap 33 openably and closably attached to a gas filler neck 32 of the fuel tank 31, the charge pipe 5 that penetrates the fuel tank 31 and is connected to the gas filler cap 33, the vaporized fuel storage 6 connected to the charge pipe 5 outside of the fuel tank 31, and the purge pipe 8 through which the vaporized fuel storage 6 communicates with the connecting tube 7 constituting a part of an intake system. The vaporized fuel storage 6 is provided with the drain pipe 6A that intakes air.

A vehicle-body cover 27 covers the fuel tank 31. An openable and closable lid 28 is provided to the vehicle-body cover 27 at a position above the gas filler cap 33. When the lid 28 is opened, the gas filler cap 33 is exposed to the outside of the vehicle-body cover 27. The lid 28 has an arm part 29 on the inner surface thereof, and is rotatably supported by this arm part 29 at an inner wall of the vehicle-body cover 27.

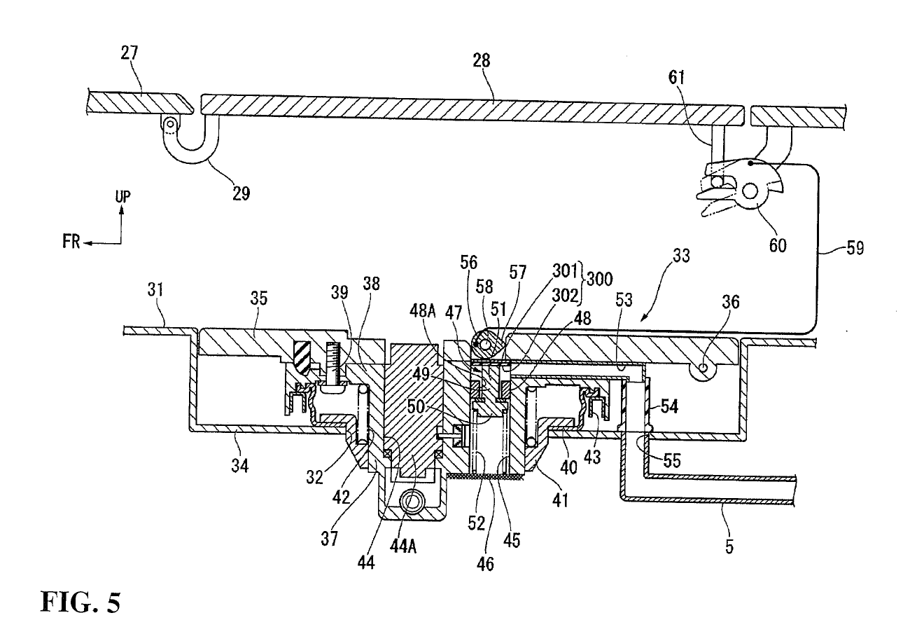

Referring to FIG. 5, a seat portion 34 is formed in the fuel tank 31. The seat portion 34 has a depressed shape in cross section and depresses by bending from an upper portion of an external wall of the fuel tank 31. The gas filler neck 32 has a circular shape in a plan view (a top view), and is formed in an area at the substantial center of the seat portion 34. The charge pipe 5 communicates with the inside of the fuel tank 31 via the gas filler cap 33, and transfers vaporized fuel generated inside the fuel tank 31 to the vaporized fuel storage 6.

The gas filler cap 33 has a cap body 35 shaped like a circular plate. The cap body 35 is coupled to the fuel tank 31 by a hinge 36, and is openable and closable. A circular-column-shaped body cap 37 is provided on the lower surface of the cap body 35. The body cap 37 has a flange portion 38 integrally at its upper end edge, and is fixed to the lower surface of the cap body 35 by multiple screws 39 penetrating the flange portion 38.

A seal material 40 made of a resin material is fit on the body cap 37, and is in pressure contact with the inner circumferential surface of the gas filler neck 32. In addition, a guide cap 41 is fit on the body cap 37 at the inner circumferential side of the seal material 40. The guide cap 41 is biased downward by a spring 42, one end of which comes into contact with the inner circumferential side of the flange portion 38 of the body cap 37.

An upper end portion of the guide cap 41 is bent in an outer circumferential direction, and the bent portion comes into contact with the seal material 40 hanging from the outer circumferential side of the flange portion 38 of the body cap 37. The position of the guide cap 41 is thus restricted. A fixing member 43 is provided for fixing the seal material 40.

A cylinder space 44 is formed in the body cap 37, and a key cylinder 44A is housed in the cylinder space 44. The key cylinder 44A unlocks the body cap 37 when rotated with a key being inserted thereinto. More specifically, the key cylinder 44A has a lock piece (not shown) that moves inward or outward in a radial direction of the key cylinder 44A in accordance with the rotation of the key. The lock piece is locked in a restraining part (not shown) provided to the fuel tank 31 to thereby restrict the opening of the body cap 37.

A communicating space 45 that extends in parallel with the cylinder space 44 of the body cap 37 is formed on the side of the cylinder space 44. A lower end portion of the communicating space 45 opens to the inside of the fuel tank 31, and is covered with a filter member 46, e.g., a mesh, through which vaporized fuel and liquid fuel can pass. An upper end portion of the communicating space 45 is sealingly covered with a combination member 300 having a press plate 301 made of a metallic material and an elastic sheet 302 made of a resin material.

A negative-pressure adjustment valve 47 is provided in the communicating space 45 and separates the communicating space 45 into a lower part on the inner side of the fuel tank 31 and an upper part on the outer side of the fuel tank 31. The negative-pressure adjustment valve 47 is biased with a predetermined biasing force from the inner side of the fuel tank 31, and opens when the internal pressure of the fuel tank 31 is a predetermined pressure or below.

The negative-pressure adjustment valve 47 includes a valve seat 48 having a hole portion 48A formed by protruding from an inner circumferential surface of the communicating space 45 inward in the radial direction; a valve body 51 having a shaft portion 49 that is fit and inserted into the hole portion 48A of the valve seat 48 and an umbrella portion 50 that is linked to a lower end of the shaft portion 49 and comes into contact with the valve seat from the inside of the fuel tank 31. A spring 52 is provided wherein one end of which comes into contact with the filter member 46 and the other end of which comes into contact with the umbrella portion 50 of the valve body 51 and biases the valve body 51 upward. The spring 52 is provided in a compressed state between the filter member 46 and the valve body 51, and exerts a predetermined biasing force toward the valve body 51.

While the upper end portion of the communicating space 45 is closed with the lower surface of the body cap 37 (i.e., the press plate 301 and the elastic sheet 302), an in-cap charge path 53 extending in a radial direction of the flange portion 38 is formed in an upper portion of an inner circumferential surface of the communicating space 45. The in-cap charge path 53 penetrates into the inside of the flange portion 38, and is open to the bottom in a space formed between the body cap 37 and the seat portion 34.

A cylinder-shaped cylindrical elastic member 54 is sealingly coupled to the opening, facing downward, of the in-cap charge path 53, and a lower end portion of the cylindrical elastic member 54 is in tight contact with the seat portion 34 while the body cap 37 is closed, and covers a communication opening 55 formed in the seat portion 34. The communication opening 55 is a hole penetrating from the seat portion 34 to the inside of the fuel tank 31, and is connected sealingly to the charge pipe 5 placed inside the fuel tank 31. Thereby, a path from the inside of the fuel tank 31 to the vaporized fuel storage 6 is formed.

In the present embodiment, the upper end of the shaft portion 49 of the negative-pressure adjustment valve 47 comes into contact with the elastic sheet 302, and a cam member 56 is rotatably supported at the cap body 35 above the press plate 301 and the elastic sheet 302. The press plate 301 and the elastic sheet 302 are located on the rotation trace of a cam mountain portion 57 around a shaft portion 58, the cap mountain portion 57 protruding from the cam member 56 outward in the radial direction.

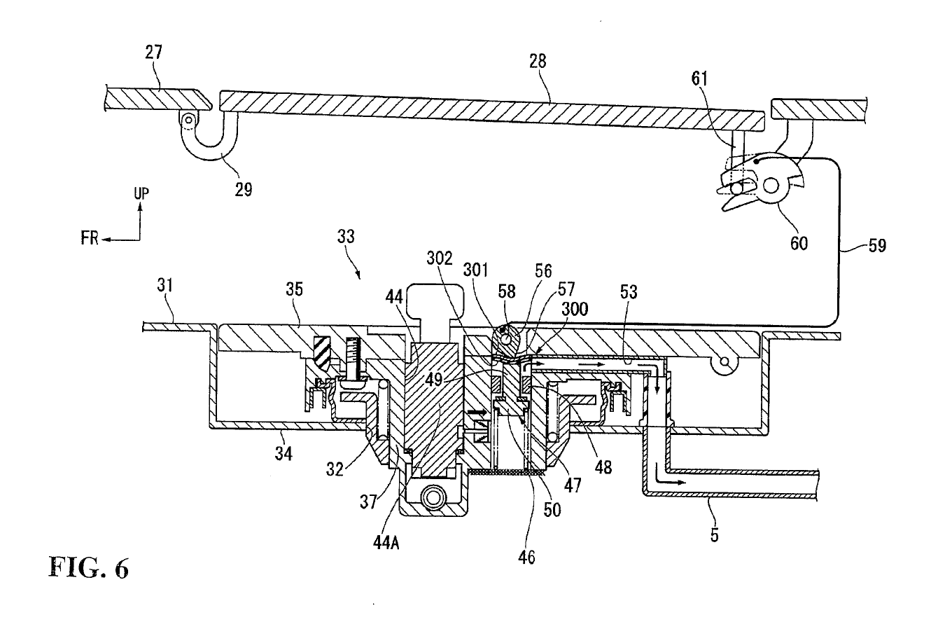

A cable 59 is connected to the cam member 56 to rotate the cam member 56 around the shaft portion 58. The cable 59 is then connected to a latch 60 provided to the inner wall of the vehicle-body cover 27 on a swinging end side of the lid 28. The latch 60 is supported rotatably, and locks a striker 61 provided to the lid 38 and thereby keeps the lid 38 in a closed state. Referring to FIG. 6, the latch 60 rotates downward when the lid 28 is pushed downward, and then the locked state with the striker 61 is released to allow the lid 28 to open.

Still referring to FIG. 6, in the vaporized fuel treatment apparatus 30 of the above-described configuration, when the lid 28 is pushed downward to rotate the latch 60 downward, the cable 59 is pulled to rotate the cam member 56, and the cam mountain portion 57 then presses the press plate 301 and the elastic sheet 302, lowering the valve body 51. When the negative-pressure adjustment valve 47 is opened in conjunction with the opening action of the lid 28 in this way, the inside of the fuel tank 31 communicates with the vaporized fuel storage 6, and thus a path is formed therebetween.

Accordingly, in the present embodiment, the negative-pressure adjustment valve 47 is opened in conjunction with the opening action of the lid 28 performed before the gas filler cap 33 is opened. Consequently, the internal pressure of the fuel tank 31 can be released toward the vaporized fuel storage 6 before the gas filler cap 33 is opened, thereby preventing leak of vaporized fuel to the atmosphere when the gas filler cap 33 is opened. Such leak is caused by the internal pressure of the fuel tank 2.

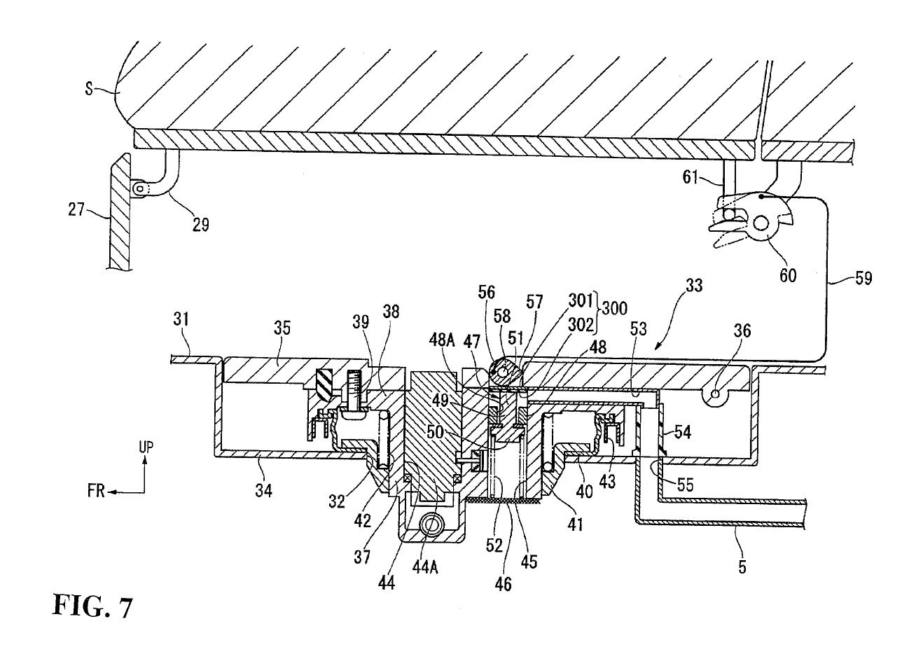

The third embodiment described above has a configuration in which the negative-pressure adjustment valve 47 is opened using the rotation of the latch 60 that keeps the lid 28 closed. However, as a modified example of the present embodiment for a configuration in which, as shown in FIG. 7, the fuel tank 31 is covered with a seat S of the vehicle, the rotation of the latch that keeps the seat S closed may be used instead.

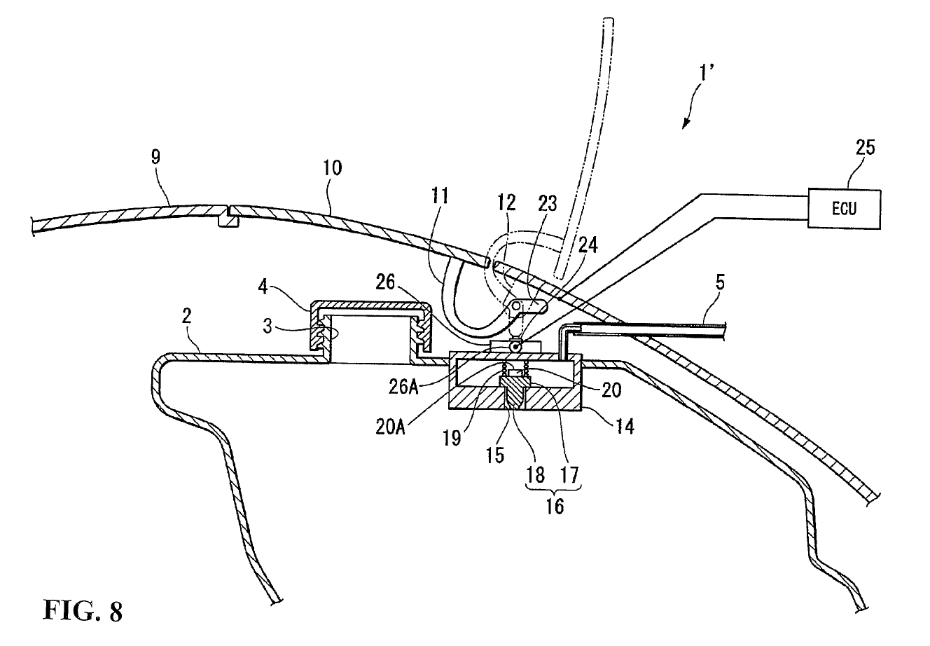

In addition, FIG. 8 shows a modified example of the second embodiment. In this example, the switch 24 is provided on an upper portion of the valve housing part 14 (or more strictly, on an upper portion of the electric magnet 26). The hinge arm part 11 is provided with the switch contact portion 23 that presses the switch 24 when the lid 10 is opened. In this configuration, when the opening action of the lid 10 makes the switch contact portion 23 press the switch 24, a current is inputted to the electric magnet 26. Note that the switch 24 may be provided on the outer wall of the fuel tank 2 in this configuration.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. A vaporized fuel treatment apparatus for a vehicle including:
a fuel tank for storing fuel therein;
an openable and closable gas filler cap attached to a gas filler neck of the fuel tank;
a vaporized fuel storage for adsorbing vaporized fuel with an adsorbent and for storing therein the vaporized fuel;
a charge path through which the fuel tank communicates with the vaporized fuel storage;
a purge path through which the vaporized fuel storage communicates with an intake system of an internal-combustion engine; and
a lid for covering the gas filler cap to open and close the gas filler cap;
the vaporized fuel treatment apparatus for the vehicle comprises an on-off valve which is located between the charge path and the fuel tank, that opens when an internal pressure of the fuel tank reaches a predetermined pressure, for allowing the fuel tank to communicate with the vaporized fuel storage;
the on-off valve also opens in conjunction with an opening action of the lid at a time of gas filling; and
upon the opening action of the lid before an opening action of the gas filler cap, the fuel tank is caused to communicate with the vaporized fuel storage to release the vaporized fuel in the fuel tank to the vaporized fuel storage.

2. The vaporized fuel treatment apparatus for a vehicle according to claim 1, wherein the lid includes a hinge arm part, said lid being rotatably supported by the hinge arm part at a hinge shaft held by a vehicle-body cover covering the fuel tank;
the on-off valve is located inside the vehicle-body cover; and
the on-off valve is opened by an action of the hinge arm part.

3. The vaporized fuel treatment apparatus for a vehicle according to claim 2, wherein the on-off valve includes a valve body, a spring for biasing the valve body in a closing direction, and a first permanent magnet attached to the valve body, said on-off valve being provided inside a valve housing part provided in an outer wall of the fuel tank at a position adjacent to the gas filler cap;
the valve housing part communicates with an inside of the fuel tank via the on-off valve, and is connected to the charge path; and
the hinge arm part has a second permanent magnet placed at such a position as to approach the first permanent magnet upon the opening action of the lid.

4. The vaporized fuel treatment apparatus for a vehicle according to claim 3, wherein the on-off valve includes a positive-pressure adjustment valve that opens when the internal pressure of the fuel tank is a predetermined value or above and a negative-pressure adjustment valve that opens when the internal pressure of the fuel tank is a predetermined value or below;
the valve housing part has a predetermined volume as a vapor-liquid separation chamber;
the first permanent magnet is provided to the positive-pressure adjustment valve; and
an arcuate depressed portion depressing toward an inside of the valve housing part is provided to a wall portion of the valve housing part, the wall portion facing the positive-pressure adjustment valve, and facing the second permanent magnet of the hinge arm part when the lid is opened.

5. The vaporized fuel treatment apparatus for a vehicle according to claim 4, wherein the valve housing part is located in an upper wall portion of the fuel tank; and
the charge path is connected to a top surface of the valve housing part at a center position of the valve housing part in a vehicle-width direction when mounted on the vehicle body, and located in an area having no depressed portion.

6. The vaporized fuel treatment apparatus for a vehicle according to claim 2, wherein the on-off valve includes a valve body, a spring for biasing the valve body in a closing direction, and a first permanent magnet attached to the valve body, said on-off valve being provided inside a valve housing part provided in an outer wall of the fuel tank at a position adjacent to the gas filler cap;
an electric magnet is provided outside the valve housing part;
a switch contact portion for separating from an inner wall of the vehicle-body cover upon an opening action of the lid is provided to the hinge arm part;
a switch with which the switch contact portion comes into contact when the lid is closed is provided in the inner wall of the vehicle-body cover;
upon an opening action of the lid, the switch sends a lid open detection signal to a control device;
a current is inputted into the electric magnet in response to a lid open determination made by the control device; and
the on-off valve is opened by a magnetic force.

7. The vaporized fuel treatment apparatus for a vehicle according to claim 2, wherein the on-off valve includes a valve body, a spring for biasing the valve body in a closing direction, and a first permanent magnet attached to the valve body, said on-off valve being provided inside a valve housing part provided in an outer wall of the fuel tank;
an electric magnet is provided outside the valve housing part;
a press-type switch is provided to one of the fuel tank and the valve housing part;
a switch contact portion for pressing the switch upon an opening action of the lid is provided to the hinge aim part; and
when the switch contact portion presses the switch in response to the opening action of the lid, a current is inputted into the electric magnet, and the on-off valve is opened by a magnetic force.

8. The vaporized fuel treatment apparatus for a vehicle according to claim 1, wherein a latch for keeping the lid closed is provided on a vehicle body supporting the lid, and the on-off valve opens in conjunction with a releasing action of the latch.

9. The vaporized fuel treatment apparatus for a vehicle according to claim 8, wherein the lid is a seat of a motorcycle, and the fuel tank is covered with the seat.

10. The vaporized fuel treatment apparatus for a vehicle according to claim 1, wherein on-off valve is actuated by a cam operatively connected to lid for opening the on-off valve upon opening the lid.

11. A vaporized fuel treatment apparatus adapted for use with a vehicle comprising:
a fuel tank for storing fuel;
an openable and closable gas filler cap operatively connected to the fuel tank;
a vaporized fuel storage for adsorbing vaporized fuel;
a charge path wherein the fuel tank is selectively in communication with the vaporized fuel storage;
a purge path wherein the vaporized fuel storage is in communication with an intake system of an internal-combustion engine; and
a lid for covering the gas filler cap to provide access to the gas filler cap;
an on-off valve operatively positioned between the charge path and the fuel tank, for opening when an internal pressure of the fuel tank reaches a predetermined pressure, for allowing the fuel tank to communicate with the vaporized fuel storage;
the on-off valve being operatively connected to the lid for opening the on-off valve in conjunction with an opening action of the lid at a time of gas filling; and
upon the opening action of the lid before an opening action of the gas filler cap, the fuel tank is caused to communicate with the vaporized fuel storage to release the vaporized fuel in the fuel tank to the vaporized fuel storage.

12. The vaporized fuel treatment apparatus adapted for use with a vehicle according to claim 11, wherein the lid includes a hinge arm part, said lid being rotatably supported by the hinge arm part at a hinge shaft held by a vehicle-body cover covering the fuel tank;
the on-off valve is located inside the vehicle-body cover; and
the on-off valve is opened by an action of the hinge arm part.

13. The vaporized fuel treatment apparatus adapted for use with a vehicle according to claim 12, wherein the on-off valve includes a valve body, a spring for biasing the valve body in a closing direction, and a first permanent magnet attached to the valve body, said on-off valve being provided inside a valve housing part provided in an outer wall of the fuel tank at a position adjacent to the gas filler cap;
the valve housing part communicates with an inside of the fuel tank via the on-off valve, and is connected to the charge path; and
the hinge arm part has a second permanent magnet placed at such a position as to approach the first permanent magnet upon the opening action of the lid.

14. The vaporized fuel treatment apparatus adapted for use with a vehicle according to claim 13, wherein the on-off valve includes a positive-pressure adjustment valve that opens when the internal pressure of the fuel tank is a predetermined value or above and a negative-pressure adjustment valve that opens when the internal pressure of the fuel tank is a predetermined value or below;
the valve housing part has a predetermined volume as a vapor-liquid separation chamber;
the first permanent magnet is provided to the positive-pressure adjustment valve; and
an arcuate depressed portion depressing toward an inside of the valve housing part is provided to a wall portion of the valve housing part, the wall portion facing the positive-pressure adjustment valve, and facing the second permanent magnet of the hinge arm part when the lid is opened.

15. The vaporized fuel treatment apparatus adapted for use with a vehicle according to claim 14, wherein the valve housing part is located in an upper wall portion of the fuel tank; and
the charge path is connected to a top surface of the valve housing part at a center position of the valve housing part in a vehicle-width direction when mounted on the vehicle body, and located in an area having no depressed portion.

16. The vaporized fuel treatment apparatus adapted for use with a vehicle according to claim 12, wherein the on-off valve includes a valve body, a spring for biasing the valve body in a closing direction, and a first permanent magnet attached to the valve body, said on-off valve being provided inside a valve housing part provided in an outer wall of the fuel tank at a position adjacent to the gas filler cap;
an electric magnet is provided outside the valve housing part;
a switch contact portion for separating from an inner wall of the vehicle-body cover upon an opening action of the lid is provided to the hinge arm part;
a switch with which the switch contact portion comes into contact when the lid is closed is provided in the inner wall of the vehicle-body cover;
upon an opening action of the lid, the switch sends a lid open detection signal to a control device;
a current is inputted into the electric magnet in response to a lid open determination made by the control device; and
the on-off valve is opened by a magnetic force.

17. The vaporized fuel treatment apparatus adapted for use with a vehicle according to claim 12, wherein the on-off valve includes a valve body, a spring for biasing the valve body in a closing direction, and a first permanent magnet attached to the valve body, said on-off valve being provided inside a valve housing part provided in an outer wall of the fuel tank;
an electric magnet is provided outside the valve housing part;
a press-type switch is provided to one of the fuel tank and the valve housing part;
a switch contact portion for pressing the switch upon an opening action of the lid is provided to the hinge arm part; and
when the switch contact portion presses the switch in response to the opening action of the lid, a current is inputted into the electric magnet, and the on-off valve is opened by a magnetic force.

18. The vaporized fuel treatment apparatus adapted for use with a vehicle according to claim 11, wherein a latch for keeping the lid closed is provided on a vehicle body supporting the lid, and the on-off valve opens in conjunction with a releasing action of the latch.

19. The vaporized fuel treatment apparatus adapted for use with a vehicle according to claim 18, wherein the lid is a seat of a motorcycle, and the fuel tank is covered with the seat.

20. The vaporized fuel treatment apparatus adapted for use with a vehicle according to claim 11, wherein on-off valve is actuated by a cam operatively connected to lid for opening the on-off valve upon opening the lid.
